(19) United States
(12) Patent Application Publication
(10) Pub. No.: US 2010/0295752 A1
(43) Pub. Date: Nov. 25, 2010

(54) HIGH-FREQUENCY CIRCUIT, LOW NOISE BLOCK DOWN CONVERTER AND ANTENNA APPARATUS

(76) Inventor: Masayuki NIBE, Osaka (JP)

Correspondence Address: BIRCH STEWART KOLASCH & BIRCH, PO BOX 747, FALLS CHURCH, VA, 22040-0747, US

(21) Appl. No.: 12/782,385

(22) Filed: May 18, 2010

(30) Foreign Application Priority Data
May 19, 2009 (JP) 2009-121032(P)

(51) Int. Cl. H01Q 9/04; H01Q 1/00

(52) U.S. Cl. 343/904; 343/700 MS

(57) ABSTRACT

A high-frequency circuit includes: a first earth pattern provided on a second main surface of a dielectric substrate; a signal pattern provided on a first main surface of the dielectric substrate and configuring a microstrip line together with the dielectric substrate and the first earth pattern; a second earth pattern provided on the first main surface and spaced from the signal pattern; a metal member electrically connected to the second earth pattern, and facing the signal pattern with a spacing therebetween; and a metal casing electrically connected to the first earth pattern and the second earth pattern, and housing the dielectric substrate, the microstrip line and the metal member.

This nonprovisional application is based on Japanese Patent Application No. 2009-121032 filed on May 19, 2009, with the Japan Patent Office, the entire contents of which are hereby incorporated by reference.

### BACKGROUND OF THE INVENTION

1. Field of the Invention

The present invention relates to a high-frequency circuit, a low noise block down converter and an antenna apparatus. Particularly, the present invention relates to a high-frequency circuit in which a microstrip line is used, a low noise block down converter and an antenna apparatus.

2. Description of the Background Art

An LNB (Low Noise Block Down Converter) is attached to an antenna, called “outdoor unit,” of a bidirectional satellite transmitting and receiving system. The LNB receives, via the antenna, an RF (Radio Frequency) signal that is a weak radio wave from a satellite, and performs low noise amplification of the received RF signal and converts the frequency thereof to an intermediate frequency (IF frequency). Then, the LNB outputs the low-noise IF signal having an adequate level to an indoor unit. The aforementioned antenna and LNB allow the user to receive the satellite broadcasting service by using a terminal such as a television apparatus connected to the indoor unit.

Each circuit in the LNB is configured by, for example, a microstrip line formed on a dielectric substrate, and an electronic device mounted on the dielectric substrate. The shape of the microstrip line is designed to have an appropriate impedance. The impedance depends on the dielectric constant of the dielectric substrate and the thickness of the substrate (base material).

FIG. 19 illustrates a change in impedance of the microstrip line when the thickness of the substrate is changed. FIG. 20 illustrates FIG. 19 in the form of a graph. FIG. 21 illustrates a change in impedance of the microstrip line when the dielectric constant of the substrate is changed. FIG. 22 illustrates FIG. 21 in the form of a graph.

In FIGS. 19 to 22, R04233 produced by Rogers Corporation is used as the substrate. This substrate has a dielectric constant of 3.33 at 10 GHz and a dielectric dissipation factor of 0.0026 at 10 GHz. In addition, a signal pattern of the microstrip line provided on this substrate has a thickness of 0.036 mm. Moreover, a distance Hu from the microstrip line to a ceiling of a casing where the microstrip line is housed is 10 mm, and a distance WL from the microstrip line to a wall of this casing is 1 mm. The characteristic impedance of this microstrip line is set to 50 Ω, and the design value of the line width is 1.1 mm. In addition, f0 represents the frequency of a signal used in the measurement.

Referring to FIGS. 19 and 20, as a substrate thickness H is reduced, an impedance Z0 of the microstrip line becomes low.

Referring to FIGS. 21 and 22, as a substrate dielectric constant εr is made higher, impedance Z0 of the microstrip line becomes low.

FIG. 23 illustrates the design dimension of the 50 Ω microstrip line when the substrate thickness is changed at signal frequency f0 of 11.725 GHz. FIG. 24 illustrates the design dimension of the 50 Ω microstrip line when the substrate thickness is changed at signal frequency f0 of 1.55 GHz. FIG. 25 illustrates the relationship between substrate thickness H and a line width W shown in FIGS. 23 and 24, in the form of a graph. FIG. 26A illustrates the relationship between substrate thickness H and a pattern area S shown in FIG. 23, in the form of a graph. FIG. 26B illustrates the relationship between substrate thickness H and pattern area S shown in FIG. 24, in the form of a graph.

As shown in FIGS. 19 and 20, as substrate thickness H is reduced, impedance Z0 of the microstrip line becomes low. Accordingly, as shown in FIG. 25, by reducing substrate thickness H, the microstrip line having a characteristic impedance of 50 Ω and having a smaller pattern width can be achieved. In addition, as shown in FIGS. 26A and 26B, by reducing substrate thickness H, the microstrip line having a characteristic impedance of 50 Ω and having a smaller pattern area can be achieved.

FIG. 27 illustrates the design dimension of the 50 Ω microstrip line when substrate dielectric constant εr is changed at signal frequency f0 of 11.725 GHz. FIG. 28 illustrates the design dimension of the 50 Ω microstrip line when substrate dielectric constant εr is changed at signal frequency f0 of 1.55 GHz. FIG. 29 illustrates the relationship between substrate dielectric constant εr and line width W shown in FIGS. 27 and 28, in the form of a graph. FIG. 30A illustrates the relationship between substrate dielectric constant εr and pattern area S shown in FIG. 27, in the form of a graph. FIG. 30B illustrates the relationship between substrate dielectric constant εr and pattern area S shown in FIG. 28, in the form of a graph.

As shown in FIGS. 21 and 22, as substrate dielectric constant εr is made higher, impedance Z0 of the microstrip line becomes low. Accordingly, as shown in FIG. 29, by making substrate dielectric constant εr higher, the microstrip line having a characteristic impedance of 50 Ω and having a smaller pattern width can be achieved. In addition, as shown in FIGS. 30A and 30B, by making substrate dielectric constant εr higher, the microstrip line having a characteristic impedance of 50 Ω and having a smaller pattern area can be achieved.

Japanese Patent Laying-Open No. 04-282901 (Patent Document 1) and Japanese Patent Laying-Open No. 06-291527 (Patent Document 2) disclose using the above technique to downsize a microstrip line. According to Patent Documents 1 and 2, a dielectric having a higher dielectric constant than that of a dielectric substrate is provided on the dielectric substrate, and a microstrip line is formed on the dielectric.

Specifically, Patent Document 1 discloses a high-frequency circuit including a microstrip line, an insulator and an earth, an insulating film being formed as the insulator, and the microstrip line being on the insulating film The microstrip line is formed by a thin film Patent Document 2 discloses a microstrip line resonator having the following configuration. A conductor layer is formed, as a ground layer, on one surface of a dielectric substrate, and a strip-shaped conductor line is formed on the other surface of the dielectric substrate, to configure a microstrip line. The conductor line of the microstrip line is cut to a prescribed length to form a resonator. Then, a region having a higher dielectric constant than that of the dielectric substrate is formed in a region of the dielectric member interposed between the conductor layer and the conductor line, which includes the site where the resonator is formed.

In addition, in Japanese Patent Laying-Open No. 2000-278005 (Patent Document 3) and Japanese Patent Laying-Open No. 2008-035336 (Patent Document 4), in a dielectric substrate, a cavity is provided in a surface opposite to a surface where a conductor pattern of a microstrip line is formed, thereby arbitrarily setting the effective dielectric constant of the substrate in the cavity portion. As a result, the impedance of the microstrip line is adjusted.

Specifically, Patent Document 3 discloses a distributed constant element including: a dielectric substrate arranged on a base substance with a first space layer interposed therebetween and having a specific pattern on a surface; and a shield layer arranged on a region that covers the specific pattern, with a second space layer interposed therebetween. At least one of the first space layer and the second space layer is filled with a dielectric material, and the dielectric material filled in the first space layer is the same as or different from that filled in the second space layer. Patent Document 4 discloses a high-frequency circuit substrate including: a semiconductor element; an impedance matching circuit connected to the semiconductor element; a signal line connected to the impedance matching circuit; a dielectric substrate where the signal line and the impedance matching circuit are formed on the surface thereof; and a cavity portion formed in a portion of a rear surface of the dielectric substrate that corresponds to a portion where the impedance matching circuit is formed.

In addition, Japanese Patent Laying-Open No. 08-078579 (Patent Document 5) discloses a mounter for a high-frequency element. The mounter includes: a conductive package cover; and a high-frequency circuit substrate housed in the cover. High-frequency lines are formed on both surfaces of the substrate. The two high-frequency lines are interconnected by a connection line provided at a peripheral part of the substrate. The spacing between the side peripheral surface of the substrate and the inner surface of the package cover, that is, the spacing between the connection line and the inner surface of the package cover is set to a prescribed value. As a result, the characteristic impedance of the connection line is adjusted.

The method for downsizing the microstrip line by reducing the substrate thickness or by making the substrate dielectric constant higher as in the prior art, however, has the following problems.

First, the method for reducing the substrate thickness has limitations in terms of manufacturing technique, and in addition, thinning of the substrate causes a decrease in the strength of the substrate. Therefore, it is more difficult in terms of both technique and quality to reduce the substrate thickness to a value larger than or equal to a certain value.

In the method in which a substrate having a high dielectric constant is used, it is required that the substrate has a dielectric dissipation factor that is equivalent to that of the presently used dielectric substrate. In other words, since a loss of a transmitted signal increases as the dielectric dissipation factor increases, a substrate having a small dielectric dissipation factor is required in the high-frequency circuit substrate. However, there are not many types of the material having a high dielectric constant and a low dielectric dissipation factor, and in addition, such material is expensive.

In order to solve these problems, it is required to find a method for downsizing the microstrip line while using the substrate made of the presently used dielectric material and having a thickness that is larger than or equal to a certain value.

### SUMMARY OF THE INVENTION

The present invention has been made to solve the above problems, and an object thereof is to provide a high-frequency circuit, a low noise block down converter and an antenna apparatus that can achieve downsizing of a microstrip line with ease and at low cost.

In order to solve the above problems, a high-frequency circuit according to an aspect of the present invention includes: a dielectric substrate having a first main surface and a second main surface provided on an opposite side of the first main surface; a first earth pattern provided on the second main surface; a signal pattern provided on the first main surface and configuring a microstrip line together with the dielectric substrate and the first earth pattern; a second earth pattern provided on the first main surface and spaced from the signal pattern; a metal member electrically connected to the second earth pattern, and facing the signal pattern with a spacing between the metal member and the signal pattern; and a metal casing electrically connected to the first earth pattern and the second earth pattern, and housing the dielectric substrate, the microstrip line and the metal member.

Preferably, the metal member is provided to surround the signal pattern and extend along a direction in which the signal pattern extends.

Preferably, the metal member is integral with the metal casing.

Preferably, the metal casing has a cutout portion being in close contact with the second earth pattern and forming a space that covers the signal pattern, and the metal member is configured by the cutout portion.

In order to solve the above problems, a low noise block down converter according to an aspect of the present invention includes: a mixer for converting a frequency of a received radio signal; and a high-frequency circuit for transmitting the radio signal or a signal whose frequency is converted by the mixer, and the high-frequency circuit includes: a dielectric substrate having a first main surface and a second main surface provided on an opposite side of the first main surface; a first earth pattern provided on the second main surface; a signal pattern provided on the first main surface and configuring a microstrip line together with the dielectric substrate and the first earth pattern; a second earth pattern provided on the first main surface and spaced from the signal pattern; a metal member electrically connected to the second earth pattern, and facing the signal pattern with a spacing between the metal member and the signal pattern, and a metal casing electrically connected to the first earth pattern and the second earth pattern, and housing the dielectric substrate, the microstrip line and the metal member.

In order to solve the above problems, an antenna apparatus according to an aspect of the present invention includes: an antenna for receiving a radio signal; and a low noise block down converter for amplifying the radio signal and converting a frequency of the radio signal, the low noise block down converter includes: a mixer for converting the frequency of the radio signal; and a high-frequency circuit for transmitting the radio signal or a signal whose frequency is converted by the mixer, and the high-frequency circuit includes: a dielectric substrate having a first main surface and a second main surface provided on an opposite side of the first main surface; a first earth pattern provided on the second main surface; a signal pattern provided on the first main surface and configuring a microstrip line together with the dielectric substrate and the first earth pattern; a second earth pattern provided on the first main surface and spaced from the signal pattern; a metal member electrically connected to the second earth pattern, and facing the signal pattern with a spacing between the metal member and the signal pattern; and a metal casing electrically connected to the first earth pattern and the second earth pattern, and housing the dielectric substrate, the microstrip line and the metal member.

According to the present invention, downsizing of the microstrip line can be achieved with ease and at low cost.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a configuration diagram of a bidirectional satellite transmitting and receiving system with an LNB including a high-frequency circuit according to a first embodiment of the present invention.

FIG. 2 is a functional block diagram of the LNB including the high-frequency circuit according to the first embodiment of the present invention.

FIG. 3 is a perspective view of a configuration of the high-frequency circuit according to the first embodiment of the present invention.

FIG. 4A is a cross-sectional view of the configuration of the high-frequency circuit according to the first embodiment of the present invention.

FIG. 4B is a top view of the configuration of the high-frequency circuit according to the first embodiment of the present invention.

FIG. 5 illustrates a change in impedance of the microstrip line when distance Hu between a signal pattern 11 and a ceiling portion of a metal member 12 as well as distance WL between signal pattern 11 and a wall portion of metal member 12 are each changed.

FIG. 6A is a graph when distance Hu is changed in FIG. 5.

FIG. 6B is a graph when distance WL is changed in FIG. 5.

FIG. 7A illustrates the design dimension of the 50 Ω microstrip line when distance Hu and distance WL are each changed at signal frequency f0 of 11.725 GHz.

FIG. 7B illustrates the design dimension of the 50 Ω microstrip line when distance Hu and distance WL are each changed at signal frequency f0 of 1.55 GHz.

FIG. 8A illustrates the relationship between distance Hu and line width W shown in FIGS. 7A and 7B, in the form of a graph.

FIG. 8B illustrates the relationship between distance WL and line width W shown in FIGS. 7A and 7B, in the four of a graph.

FIG. 9A illustrates the relationship between distance Hu and the pattern area shown in FIG. 7A at signal frequency f0 of 11.725 GHz, in the form of a graph. FIG. 9B illustrates the relationship between distance WL and the pattern area shown in FIG. 7A at signal frequency f0 of 11.725 GHz, in the form of a graph.

FIG. 10A illustrates the relationship between distance Hu and the pattern area shown in FIG. 7B at signal frequency f0 of 1.55 GHz, in the form of a graph.

FIG. 10B illustrates the relationship between distance WL and the pattern area shown in FIG. 7B at signal frequency f0 of 1.55 GHz, in the form of a graph.

FIG. 11 is a perspective view of a configuration of a high-frequency circuit according to a second embodiment of the present invention.

FIG. 12 is a cross-sectional view of the configuration of the high-frequency circuit according to the second embodiment of the present invention.

FIG. 13 is a perspective view of a configuration of a high-frequency circuit according to a third embodiment of the present invention.

FIG. 14 is a cross-sectional view of the configuration of the high-frequency circuit according to the third embodiment of the present invention.

FIG. 15 is a perspective view of an example of the high-frequency circuit according to the third embodiment of the present invention.

FIG. 16 is a cross-sectional view of the example of the high-frequency circuit according to the third embodiment of the present invention.

FIG. 17 illustrates the pass characteristic of the microstrip line in the example shown in FIGS. 15 and 16.

FIG. 18 illustrates the pass characteristic of the microstrip line when a casing 34 is removed from the high-frequency circuit in the example shown in FIGS. 15 and 16.

FIG. 19 illustrates a change in impedance of the microstrip line when the thickness of a substrate is changed.

FIG. 20 illustrates FIG. 19 in the form of a graph.

FIG. 21 illustrates a change in impedance of the microstrip line when the dielectric constant of the substrate is changed.

FIG. 22 illustrates FIG. 21 in the form of a graph.

FIG. 23 illustrates the design dimension of the 50 Ω microstrip line when the substrate thickness is changed at signal frequency f0 of 11.725 GHz.

FIG. 24 illustrates the design dimension of the 50 Ω microstrip line when the substrate thickness is changed at signal frequency f0 of 1.55 GHz.

FIG. 25 illustrates the relationship between substrate thickness H and line width W shown in FIGS. 23 and 24, in the form of a graph.

FIG. 26A illustrates the relationship between substrate thickness H and pattern area S shown in FIG. 23, in the form of a graph.

FIG. 26B illustrates the relationship between substrate thickness H and pattern area S shown in FIG. 24, in the form of a graph.

FIG. 27 illustrates the design dimension of the 50 Ω microstrip line when substrate dielectric constant εr is changed at signal frequency f0 of 11.725 GHz.

FIG. 28 illustrates the design dimension of the 50 Ω microstrip line when substrate dielectric constant εr is changed at signal frequency f0 of 1.55 GHz.

FIG. 29 illustrates the relationship between substrate dielectric constant εr and line width W shown in FIGS. 27 and 28, in the form of a graph.

FIG. 30A illustrates the relationship between substrate dielectric constant εr and pattern area S shown in FIG. 27, in the form of a graph.

FIG. 30B illustrates the relationship between substrate dielectric constant εr and pattern area S shown in FIG. 28, in the form of a graph.

### DESCRIPTION OF THE PREFERRED EMBODIMENTS

Embodiments of the present invention will be described hereinafter with reference to the drawings, wherein the same or corresponding portions are denoted by the same reference characters, and description thereof will not be repeated.

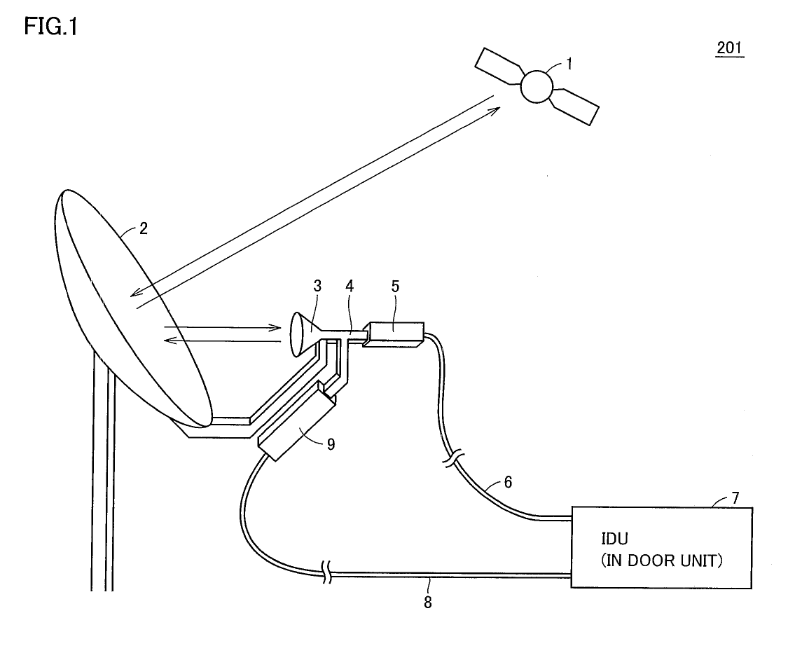

### First Embodiment

[Bidirectional Satellite Transmitting and Receiving System]FIG. 1 is a configuration diagram of a bidirectional satellite transmitting and receiving system with an LNB including a high-frequency circuit according to a first embodiment of the present invention.

Referring to FIG. 1, a bidirectional satellite transmitting and receiving system (antenna apparatus) 201 includes a parabolic antenna 2, a feedhorn 3, an OMT (Orthogonal Mode Transfer) 4, an LNB (Low Noise Block down converter) 5, a receiving coaxial cable 6, an indoor unit 7, a transmitting coaxial cable 8, and a transmitter 9.

An RF signal (radio signal) transmitted from a bidirectional artificial satellite 1 is focused by parabolic antenna 2. Parabolic antenna 2 is also called “outdoor unit” as compared with indoor unit 7. The RF signal focused by parabolic antenna 2 is further focused by feedhorn 3 and sent to OMT 4. OMT 4 divides the wave of the RF signal sent from feedhorn 3, in accordance with the direction of cross polarization. LNB 5 converts the RF signal sent from feedhorn 3 through OMT 4, to a low-noise IF (Intermediate Frequency) signal having an adequate level. The signal output from LNB 5 is sent to indoor unit (IDU) 7 through receiving coaxial cable 6.

On the other hand, a signal output from indoor unit 7 is sent to transmitter 9 through transmitting coaxial cable 8. Transmitter 9 converts the IF signal sent through transmitting coaxial cable 8, to the RF signal having an adequate level. The RF signal output from transmitter 9 is transmitted through OMT 4, feedhorn 3 and parabolic antenna 2 to bidirectional artificial satellite 1.

This bidirectional satellite transmitting and receiving system 201 allows the user to receive the bidirectional communication service such as the satellite broadcasting and the Internet connection service by using a terminal such as a not-shown television and computer connected to indoor unit 7.

[LNB]

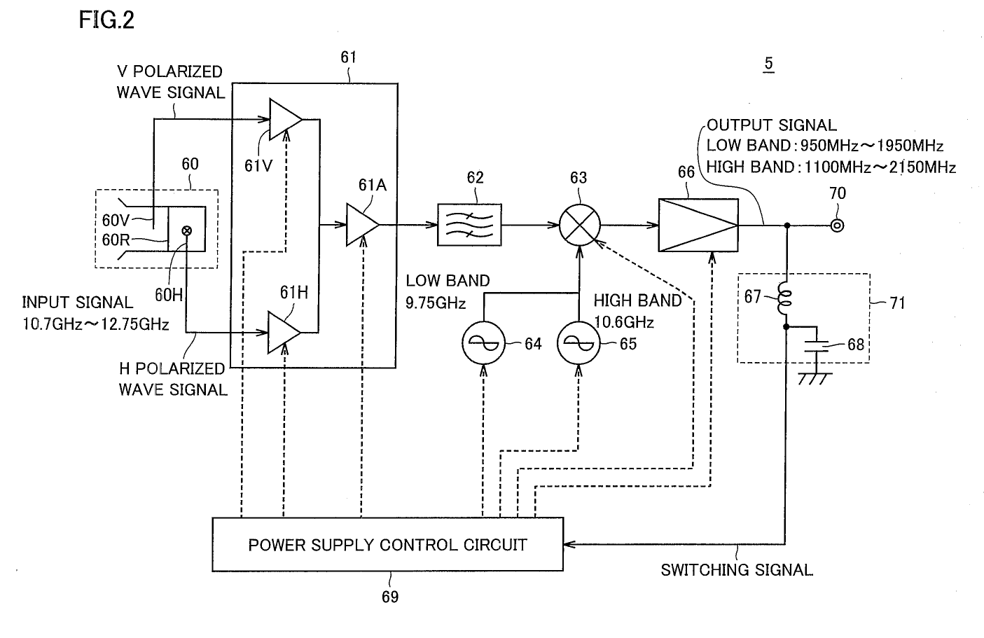

FIG. 2 is a functional block diagram of the LNB including the high-frequency circuit according to the first embodiment of the present invention.

Referring to FIG. 2, LNB 5 has a two-input, one-output configuration, and includes an input waveguide 60, an LNA (Low Noise Amplifier) 61, a BPF (Band Pass Filter) 62, a mixer 63, dielectric resonator oscillators (DROs) 64 and 65, an IF amplifier 66, a power supply control circuit 69, and an LPF (Low Pass Filter) 71.

LNA 61 includes an HEMT (High Electron Mobility Transistor) 61V, an HEMT 61H and an HEMT 61A. LPF 71 includes an inductor 67 and a capacitor 68.

An input signal having a frequency of 10.7 to 12.75 GHz that has been input to input waveguide 60 is divided into a V polarized wave signal and an H polarized wave signal by a V polarized wave reflection rod 60R placed within input waveguide 60. The V polarized wave signal is received by an antenna probe 60V in input waveguide 60, and sent to HEMT 61V in LNA 61. The H polarized wave signal is received by an antenna probe 60H in input waveguide 60, and sent to HEMT 61H in LNA 61.

LNA 61 performs low noise amplification of any one of the V polarized wave signal and the H polarized wave signal and outputs the V polarized wave signal or the H polarized wave signal to BPF 62, based on control by power supply control circuit 69. In other words, upon receiving the V polarized wave signal, HEMT 61V in LNA 61 is supplied with power from power supply control circuit 69, performs low noise amplification of the V polarized wave signal and outputs the V polarized wave signal. On the other hand, upon receiving the H polarized wave signal, power feed from power supply control circuit 69 stops, and thus, HEMT 61V does not perform the above-described process. Upon receiving the H polarized wave signal, HEMT 61H in LNA 61 is supplied with power from power supply control circuit 69, performs low noise amplification of the H polarized wave signal and outputs the H polarized wave signal. On the other hand, upon receiving the V polarized wave signal, power feed from power supply control circuit 69 stops, and thus, HEMT 61H does not perform the above-described process.

BPF 62 passes only a signal having a desired frequency band among input signals, and removes a signal having an image frequency band. The signal passed through BPF 62 is input to mixer 63.

DRO 64 generates an oscillating signal for a Low band having a frequency of 9.75 GHz, and outputs the signal to mixer 63. DRO 65 generates an oscillating signal for a High band having a frequency of 10.6 GHz, and outputs the signal to mixer 63.

Power supply control circuit 69 supplies power to DRO 64 and stops power supply to DRO 65 upon receiving the Low band signal. In addition, power supply control circuit 69 supplies power to DRO 65 and stops power supply to DRO 64 upon receiving the High band signal. As a result, the oscillating signal is output only from any one of DRO 64 and DRO 65, in response to switching between the Low band and the High band.

Mixer 63 receives the oscillating signal from DRO 64 or DRO 65, and converts the frequency of the signal received from BPF 62, to the IF signal having a frequency of 950 to 1950 MHz, upon selecting the reception of the Low band signal. In addition, mixer 63 converts the frequency of the signal received from BPF 62, to the IF signal having a frequency of 1100 to 2150 MHz, upon selecting the reception of the High band signal.

IF amplifier 66 has an appropriate noise characteristic and gain characteristic. IF amplifier 66 amplifies the IF signal received from mixer 63 and outputs the IF signal to an output terminal 70.

By connecting a television set as a receiver to output terminal 70, a broadcast program having the Low band and the High band can be watched,

Power supply control circuit 69 receives, through LPF 71, a signal for supplying and switching a DC bias. In addition, power supply control circuit 69 selects the V polarized wave signal or the H polarized wave signal and controls power supply to HEMT 61V and HEMT 61H as described above, based on a switching signal from the receiver. In addition, power supply control circuit 69 selects the Low band signal or the High band signal and controls power supply to DRO 64 and DRO 65 as described above, based on the switching signal from the receiver. Here, the DC voltage of the switching signal from the receiver is set to 13 V when the switching signal represents the V polarized wave signal, and is set to 17 V when the switching signal represents the H polarized wave signal. In addition, the switching signal from the receiver is set to a pulse signal of 22 kHz when the switching signal represents the High band signal, and is set to a signal including only a DC component when the switching signal represents the Low band signal. Furthermore, power supply control circuit 69 supplies power to HEMT 61A, mixer 63 and IF amplifier 66.

It is noted that LPF 71 passes only a signal having a low frequency band, and thus, power supply control circuit 69 does not receive the IF signal output by IF amplifier 66.

[High-frequency Circuit]

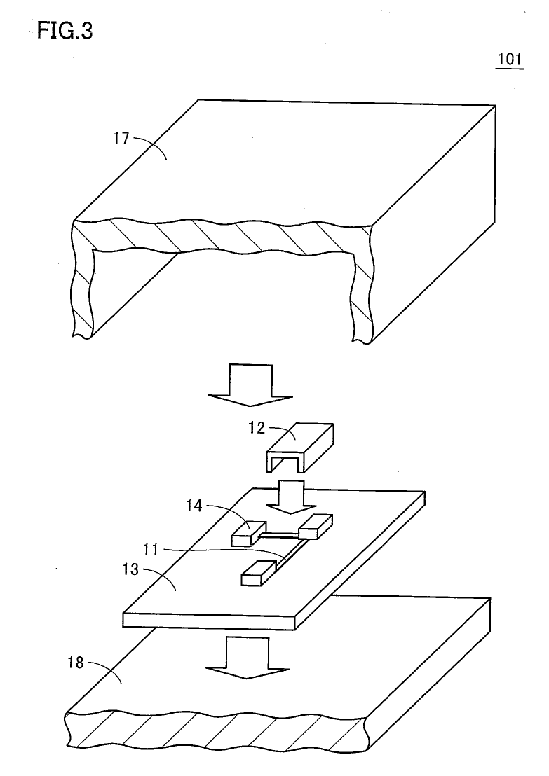

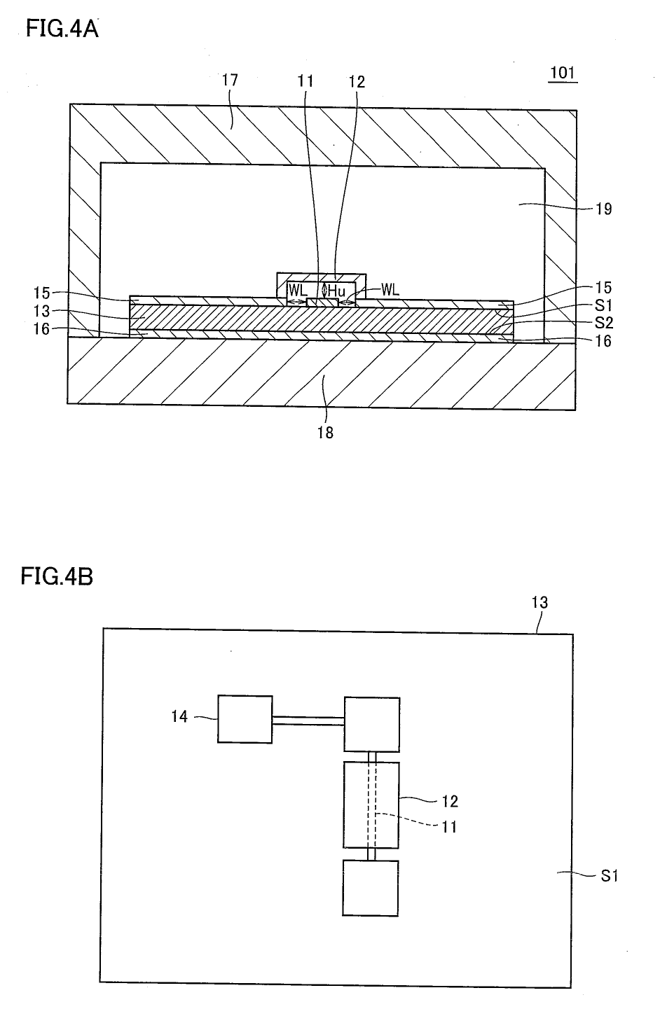

FIG. 3 is a perspective view of a configuration of the high-frequency circuit according to the first embodiment of the present invention. FIG. 4A is a cross-sectional view of the configuration of the high-frequency circuit according to the first embodiment of the present invention. FIG. 4B is a top view of the configuration of the high-frequency circuit according to the first embodiment of the present invention.

Referring to FIGS. 3, 4A and 4B, a high-frequency circuit 101 includes a signal pattern 11, a metal member 12, a dielectric substrate 13, an electronic component 14, a second earth pattern 15, a first earth pattern 16, and metal casings 17 and 18.

Dielectric substrate 13 has a first main surface S1 having electronic component 14 mounted thereon, and a second main surface S2 provided on the opposite side of first main surface S1. First earth pattern 16 is provided on second main surface S2. Signal pattern 11 is provided on first main surface S1 and configures a microstrip line together with dielectric substrate 13 and first earth pattern 16. Second earth pattern 15 is provided on first main surface S1 and is spaced from signal pattern 11.

Metal casings 17 and 18 are electrically connected to second earth pattern 15 and first earth pattern 16, and house and fix signal pattern 11, metal member 12, dielectric substrate 13, electronic component 14, first earth pattern 16, and second earth pattern 15. More specifically, metal casing 17 is attached to metal casing 18 to form a space 19 for housing signal pattern 11, metal member 12, dielectric substrate 13, electronic component 14, first earth pattern 16, and second earth pattern 15. Metal casing 18 is in close contact with first earth pattern 16 and electrically connected to second earth pattern 15 by a not-shown through hole provided in dielectric substrate 13.

Metal member 12 is fabricated by press working of a sheet metal. Metal member 12 is electrically connected to second earth pattern 15 and faces signal pattern 11 with a spacing therebetween. Specifically, metal member 12 is provided to surround signal pattern 11 and extend along the direction in which signal pattern 11 extends. Metal member 12 is connected to second earth pattern 15 with solder. It is noted that metal member 12 can be fixed to dielectric substrate 13 with a screw and the like.

The microstrip line in high-frequency circuit 101 is used as a line for transmitting the RF signal and the IF signal of LNB 5 shown in FIG. 2. For example, when high-frequency circuit 101 is applied to a signal line between IF amplifier 66 and output terminal 70 that is longer than other signal lines, the effect of downsizing the microstrip line becomes more prominent.

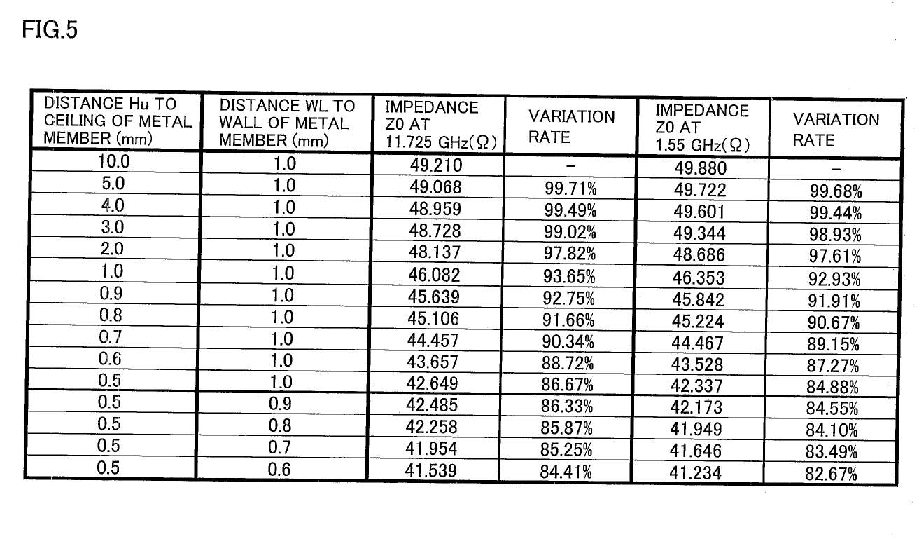

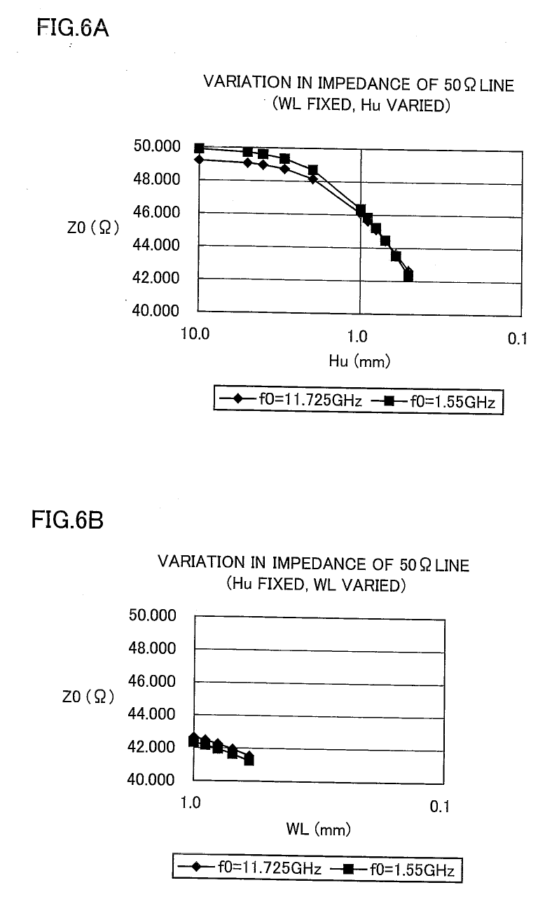

FIG. 5 illustrates a change in impedance of the microstrip line when distance Hu between signal pattern 11 and a ceiling portion of metal member 12 as well as distance WL between signal pattern 11 and a wall portion of metal member 12 are each changed. FIG. 6A is a graph when distance Hu is changed in FIG. 5. FIG. 6B is a graph when distance WL is changed in FIG. 5.

In FIGS. 5, 6A and 6B, R04233 produced by Rogers Corporation is used as the substrate. This substrate has a dielectric constant of 3.33 at 10 GHz and a dielectric dissipation factor of 0.0026 at 10 GHz. In addition, this substrate has a thickness of 0.5 mm Moreover, the signal pattern of the microstrip line provided on this substrate has a thickness of 0.036 mm. The characteristic impedance of this microstrip line is set to 50 Ω, and the design value of the line width is 1.1 mm In addition, f0 represents the frequency of a signal used in the measurement.

Referring to FIGS. 5 and 6A, in a state where distance WL is fixed to 1.0 mm, as distance Hu is decreased, impedance Z0 of the microstrip line becomes low.

Referring to FIGS. 5 and 6B, in a state where distance Hu is fixed to 0.5 mm, as distance WL is decreased, impedance Z0 of the microstrip line becomes low.

As described above, high-frequency circuit 101 is configured such that metal member 12 serving as a metallic shield structure is provided in the proximity of the upper side of signal pattern 11 of the microstrip line and is grounded. With this configuration, the impedance of the microstrip line can be made small by decreasing at least one of distance Hu and distance WL, without reducing the substrate thickness or making the substrate dielectric constant higher as in the prior art.

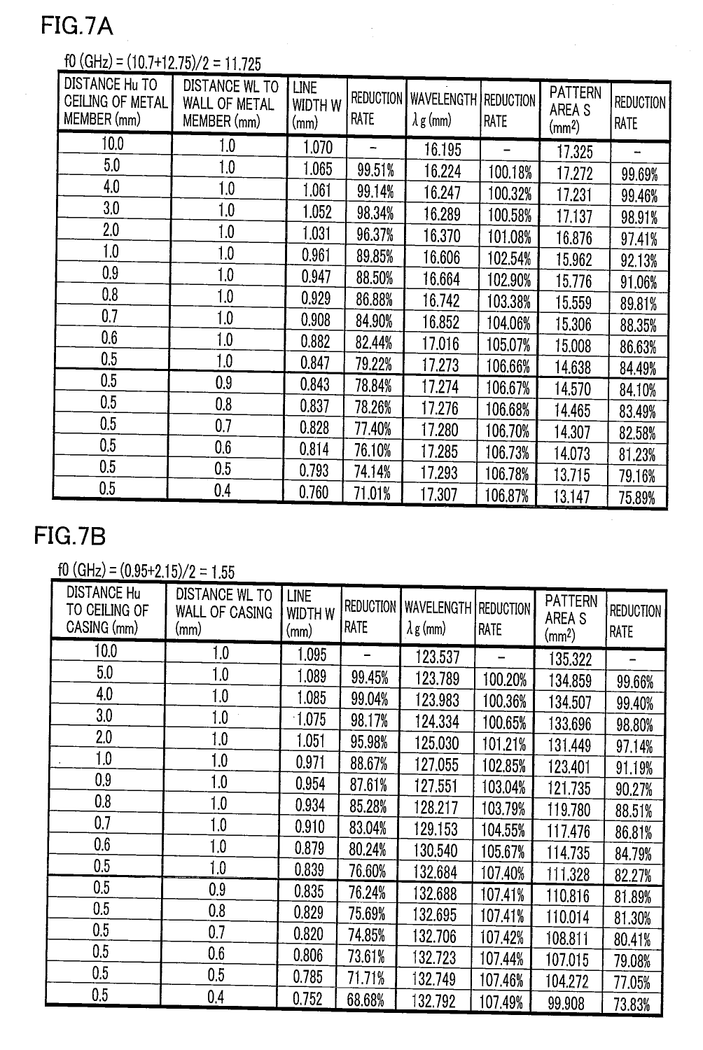

FIG. 7A illustrates the design dimension of the 50 Ω microstrip line when distance Hu and distance WL are each changed at signal frequency f0 of 11.725 GHz. FIG. 7B illustrates the design dimension of the 50 Ω microstrip line when distance Hu and distance WL are each changed at signal frequency f0 of 1.55 GHz.

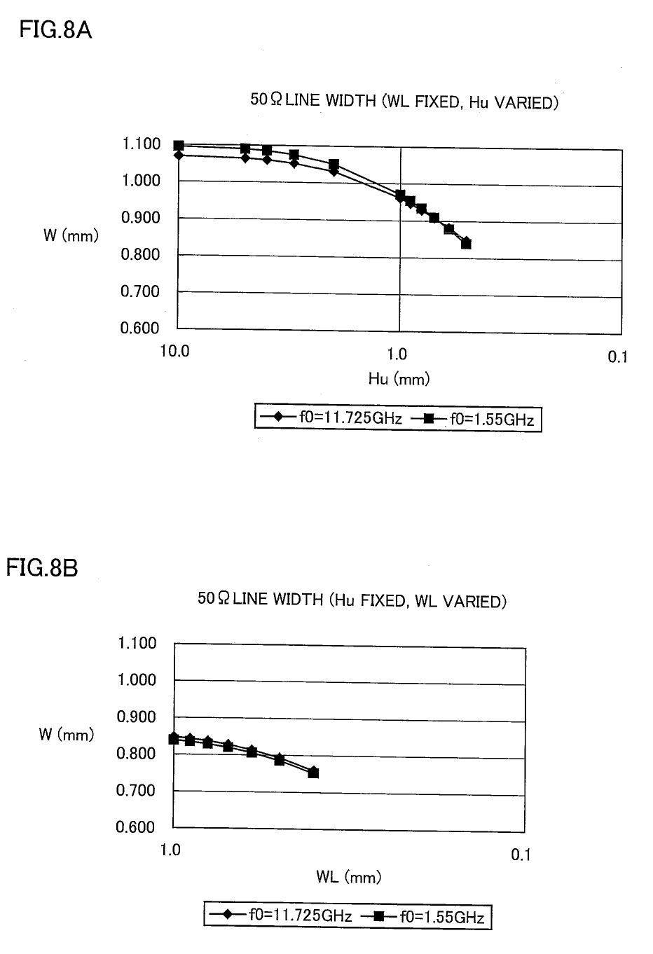

FIG. 8A illustrates the relationship between distance Hu and line width W shown in FIGS. 7A and 7B, in the form of a graph. FIG. 8B illustrates the relationship between distance WL and line width W shown in FIGS. 7A and 7B, in the form of a graph.

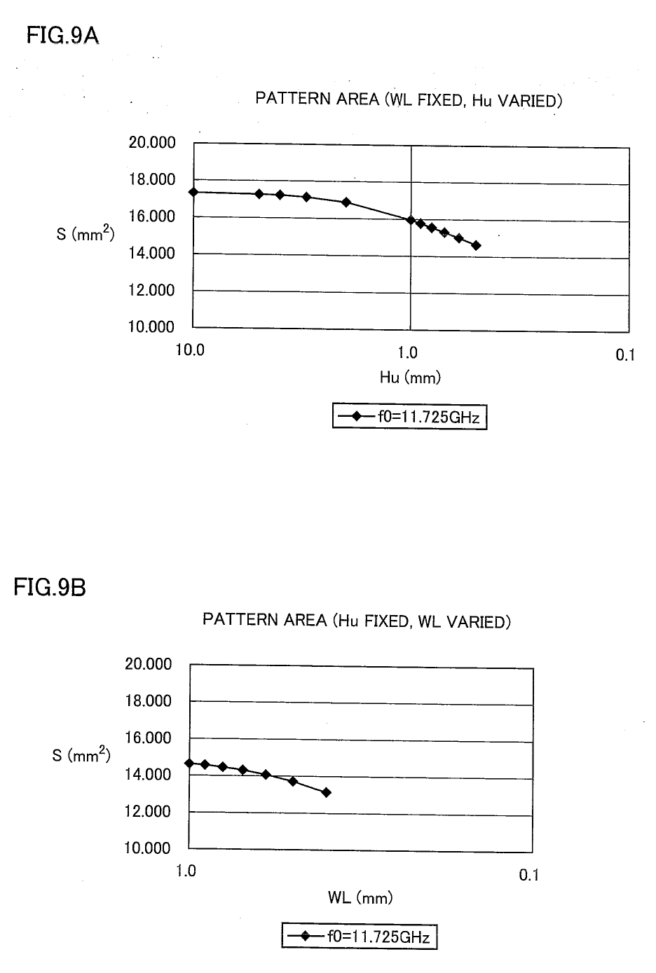

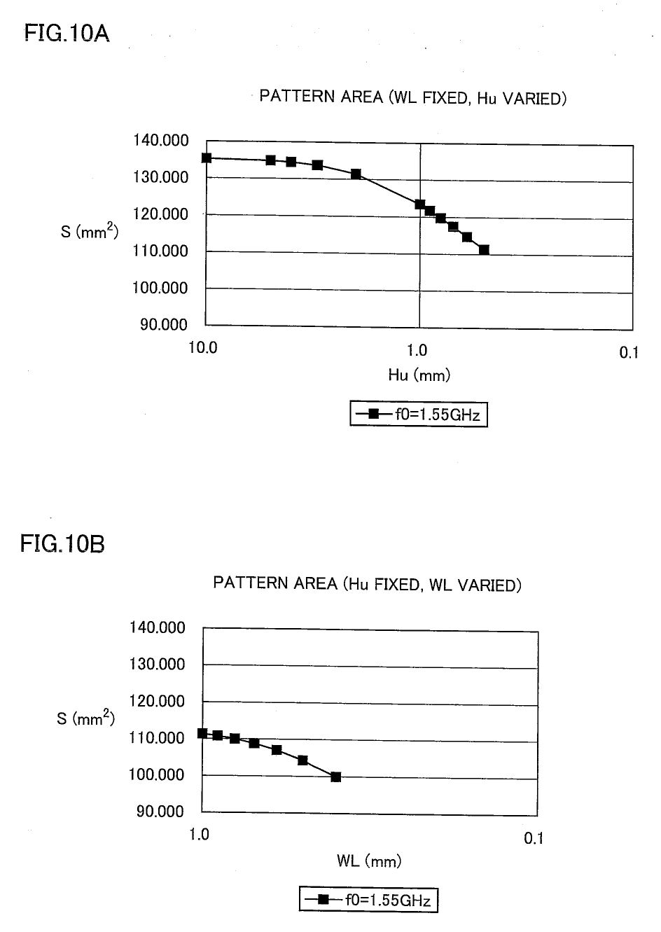

FIG. 9A illustrates the relationship between distance Hu and the pattern area shown in FIG. 7A at signal frequency f0 of 11.725 GHz, in the form of a graph. FIG. 9B illustrates the relationship between distance WL and the pattern area shown in FIG. 7A at signal frequency f0 of 11.725 GHz, in the form of a graph. FIG. 10A illustrates the relationship between distance Hu and the pattern area shown in FIG. 7B at signal frequency f0 of 1.55 GHz, in the form of a graph. FIG. 10B illustrates the relationship between distance WL and the pattern area shown in FIG. 7B at signal frequency f0 of 1.55 GHz, in the form of a graph.

As shown in FIGS. 7A, 7B, 8A, and 8B, by decreasing at least one of distance Hu and distance WL, the microstrip line having a characteristic impedance of 50 Ω and having a smaller pattern width can be achieved, without reducing the substrate thickness or making the substrate dielectric constant higher as in the prior art. In addition, as shown in FIGS. 7A, 7B, 9A, 9B, 10A, and 10B, by decreasing at least one of distance Hu and distance WL, the microstrip line having a characteristic impedance of 50 Ω and having a smaller pattern area can be achieved, without reducing the substrate thickness or making the substrate dielectric constant higher as in the prior art. In other words, in high-frequency circuit 101, the signal pattern width of the microstrip line can be reduced in the 50 Ω line design.

When distance Hu or distance WL is decreased, a wavelength λg in the direction in which the signal passing through the microstrip line travels slightly becomes enlarged. In high-frequency circuit 101, however, the reduction rate of line width W and the reduction rate of pattern area S are larger than the enlargement rate of wavelength λg. As a result, in a structure where metal casing 17 surrounding the microstrip line is located at a distance of 10 mm from signal pattern 11 of the microstrip line, for example, the area of signal pattern 11 of the microstrip line can be reduced to 77 to 79% of the original area, when the shield structure is provided at a location of 0.5 mm from the upper side as well as the right and left sides of signal pattern 11.

The method for downsizing the microstrip line by reducing the substrate thickness as in the prior art has a problem of difficulty in manufacturing. In addition, the method for downsizing the microstrip line by making the substrate dielectric constant higher has a problem of high cost.

The high-frequency circuit according to the first embodiment of the present invention, however, includes metal member 12 that is electrically connected to second earth pattern 15 and faces signal pattern 11 with a spacing therebetween. With such a configuration, the size of the microstrip line and the circuit area can be reduced while the distance between signal pattern 11 and metal member 12 is adjusted such that the microstrip line has a desired impedance. Accordingly, downsizing of the microstrip line can be achieved with ease and at low cost. Application of this high-frequency circuit allows downsizing of the LNB and the bidirectional satellite transmitting and receiving system.

Although only one signal pattern is covered with metal member 12 in FIGS. 3, 4A and 4B for ease of explanation, a plurality of signal patterns are, in reality, covered with metal member 12 in many cases. In this case, the effect of downsizing the microstrip line becomes more prominent.

In addition, in the high-frequency circuit according to the first embodiment of the present invention, metal member 12 is provided to surround signal pattern 11 and extend along the direction in which signal pattern 11 extends. With such a configuration, the size of the microstrip line can be further reduced while the microstrip line is configured to have a desired impedance.

Next, another embodiment of the present invention will be described with reference to the drawings, wherein the same or corresponding portions are denoted by the same reference characters, and description thereof will not be repeated.

### Second Embodiment

The present embodiment relates to a high-frequency circuit in which a method for implementing a metal member is modified as compared with the high-frequency circuit according to the first embodiment. The description similar to that of the high-frequency circuit according to the first embodiment is provided in the present embodiment, except for what will be described below.

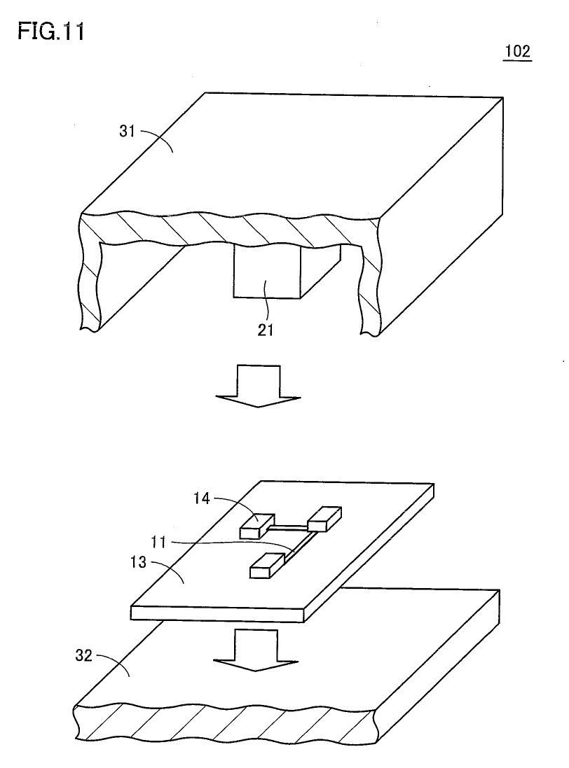

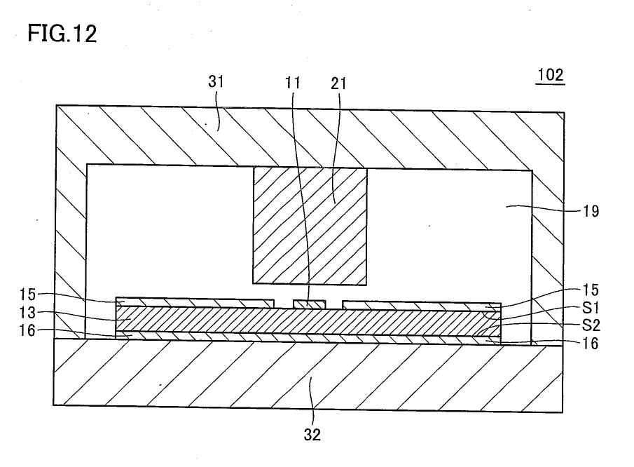

FIG. 11 is a perspective view of a configuration of a high-frequency circuit according to a second embodiment of the present invention. FIG. 12 is a cross-sectional view of the configuration of the high-frequency circuit according to the second embodiment of the present invention.

Referring to FIGS. 11 and 12, a high-frequency circuit 102 includes signal pattern 11, a metal member 21, dielectric substrate 13, electronic component 14, first earth pattern 16, second earth pattern 15, and metal casings 31 and 32.

Metal casings 31 and 32 are electrically connected to second earth pattern 15 and first earth pattern 16, and house and fix signal pattern 11, metal member 21, dielectric substrate 13, electronic component 14, first earth pattern 16, and second earth pattern 15. More specifically, casing 31 is attached to casing 32 to form space 19 for housing signal pattern 11, metal member 21, dielectric substrate 13, electronic component 14, first earth pattern 16, and second earth pattern 15. Casing 32 is in close contact with first earth pattern 16 and electrically connected to second earth pattern 15 by the not-shown through hole provided in dielectric substrate 13.

Metal member 21 is integral with metal casing 31. Metal member 21 is electrically connected to first earth pattern 16 with metal casings 31 and 32 interposed therebetween, and is electrically connected to second earth pattern 15 by the not-shown through hole provided in dielectric substrate 13. Metal member 21 faces signal pattern 11 with a spacing therebetween.

Since metal member 21 is integral with metal casing 31, it is not required to mount the metal member on the dielectric substrate, and thus, the efficiency of mounting can be enhanced, although the characteristics deteriorate to some extent as compared with the high-frequency circuit according to the first embodiment of the present invention.

The remaining configuration and operation of high-frequency circuit 102 is similar to those of the high-frequency circuit according to the first embodiment. Therefore, detailed description on them will not be repeated.

Next, another embodiment of the present invention will be described with reference to the drawings, wherein the same or corresponding portions are denoted by the same reference characters, and description thereof will not be repeated.

### Third Embodiment

The present embodiment relates to a high-frequency circuit in which a method for implementing a metal member is modified as compared with the high-frequency circuit according to the first embodiment. The description similar to that of the high-frequency circuit according to the first embodiment is provided in the present embodiment, except for what will be described below.

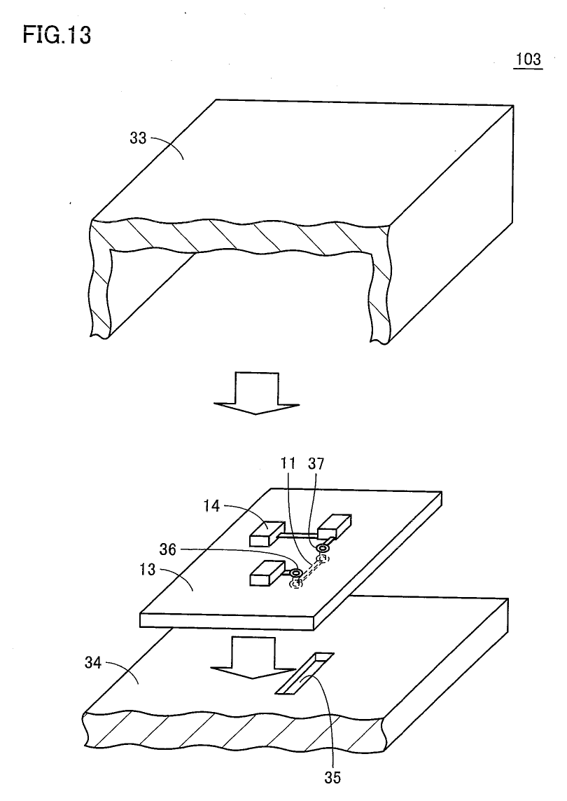

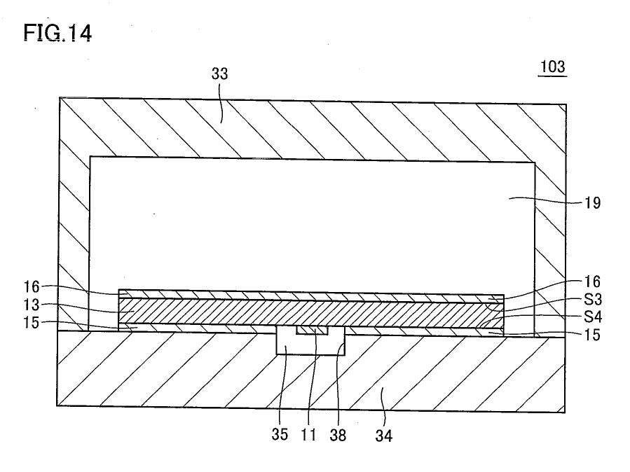

FIG. 13 is a perspective view of a configuration of a high-frequency circuit according to a third embodiment of the present invention. FIG. 14 is a cross-sectional view of the configuration of the high-frequency circuit according to the third embodiment of the present invention.

Referring to FIGS. 13 and 14, a high-frequency circuit 103 includes signal pattern 11, dielectric substrate 13, electronic component 14, second earth pattern 15, first earth pattern 16, and metal casings 33 and 34.

Dielectric substrate 13 has a main surface S3 having electronic component 14 mounted thereon, and a main surface S4 provided on the opposite side of main surface S3. First earth pattern 16 is provided on main surface S3. Signal pattern 11 is provided on main surface S4 and configures a microstrip line together with dielectric substrate 13 and first earth pattern 16. Signal pattern 11 connects electronic components 14 mounted on main surface S3, by through holes 36 and 37 provided in dielectric substrate 13.

Second earth pattern 15 is provided on main surface S4 and is spaced from signal pattern 11.

Metal casings 33 and 34 are electrically connected to second earth pattern 15 and first earth pattern 16, and house and fix signal pattern 11, dielectric substrate 13, electronic component 14, first earth pattern 16, and second earth pattern 15. More specifically, casing 33 is attached to casing 34 to form space 19 for housing signal pattern 11, dielectric substrate 13, electronic component 14, first earth pattern 16, and second earth pattern 15. Casing 34 is in close contact with second earth pattern 15 and electrically connected to first earth pattern 16 by the not-shown through hole provided in dielectric substrate 13.

Metal casing 34 is in close contact with second earth pattern 15 and has a cutout portion 38 forming a space 35 that covers signal pattern 11. Cutout portion 38 is a part of metal casing 34 and has a surface for forming space 35. Cutout portion 38 in high-frequency circuit 103 corresponds to metal member 12 in the high-frequency circuit according to the first embodiment of the present invention. Cutout portion 38 is electrically connected to second earth pattern 15 and faces signal pattern 11 with a spacing therebetween.

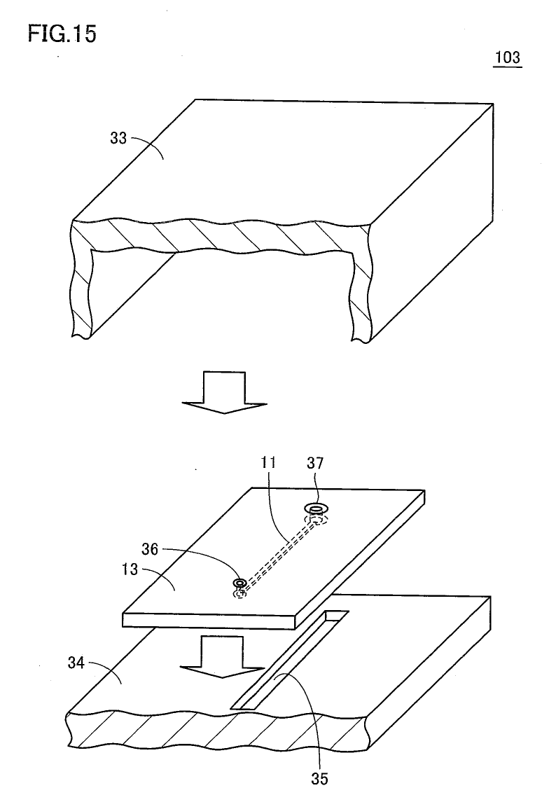

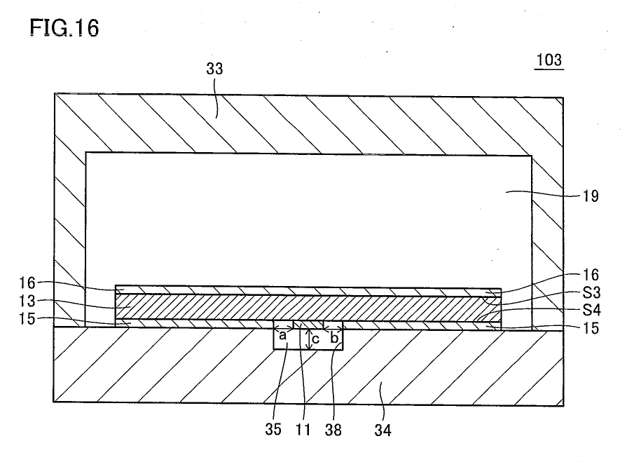

FIG. 15 is a perspective view of an example of the high-frequency circuit according to the third embodiment of the present invention. FIG. 16 is a cross-sectional view of the example of the high-frequency circuit according to the third embodiment of the present invention.

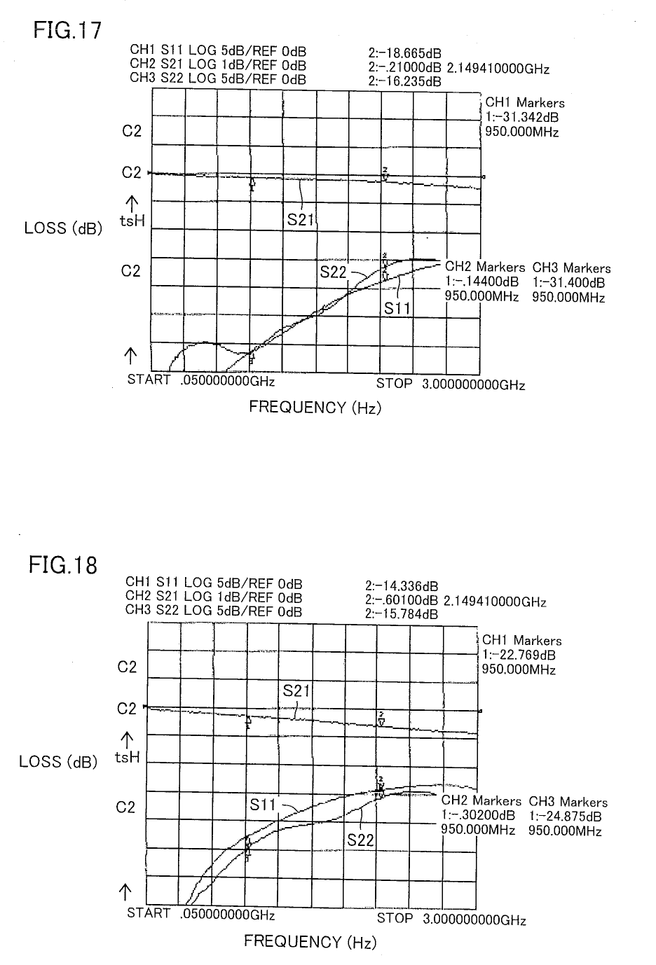

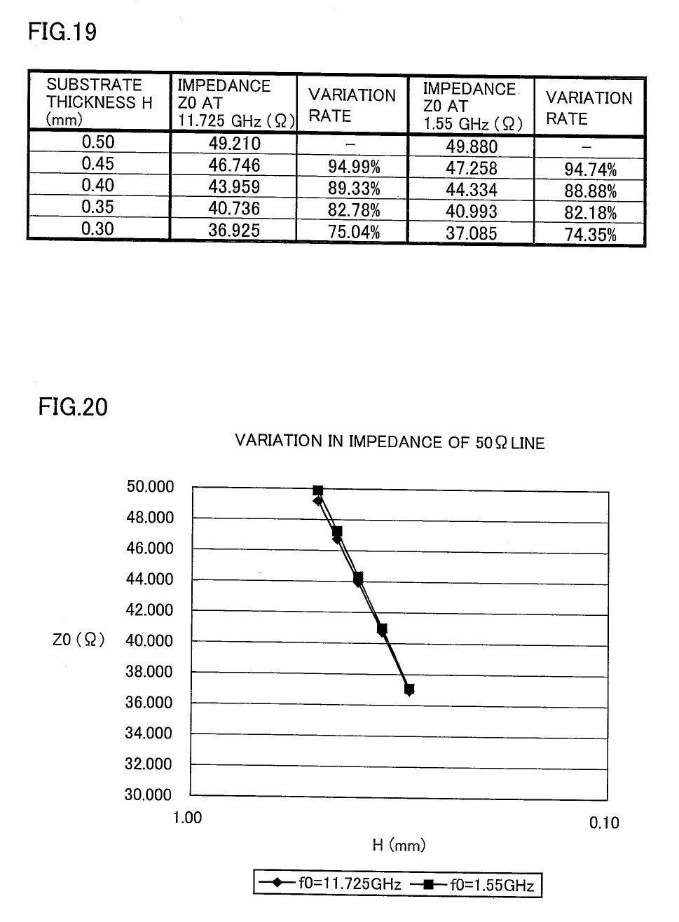

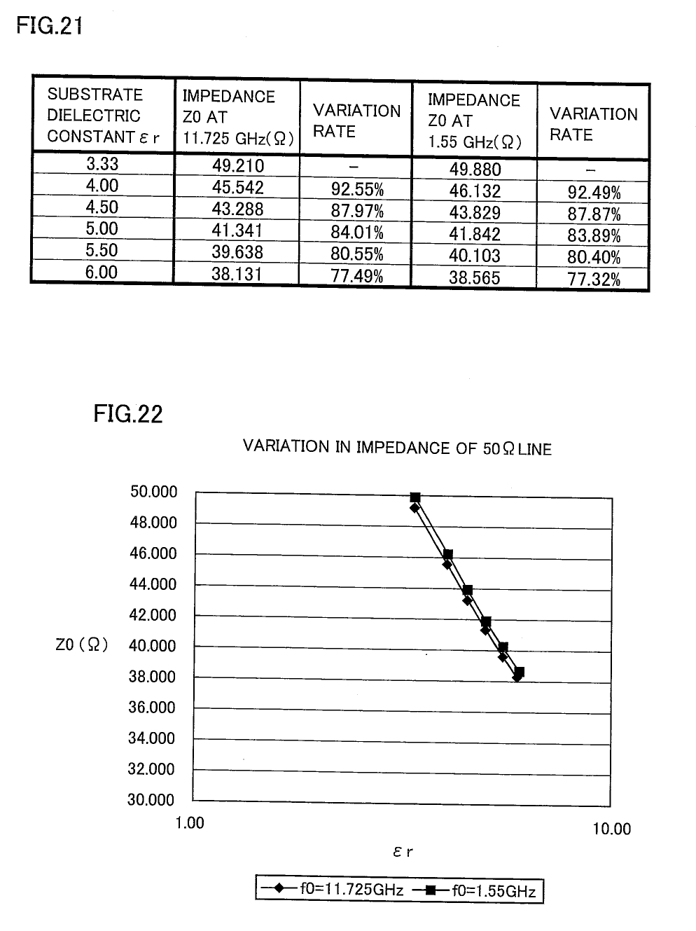

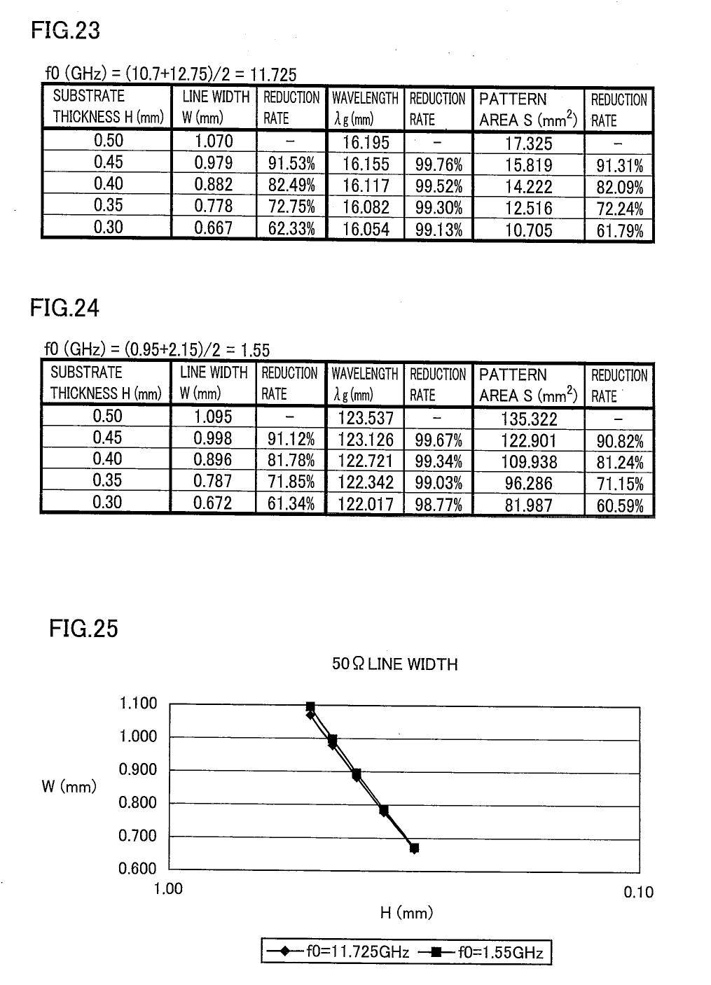

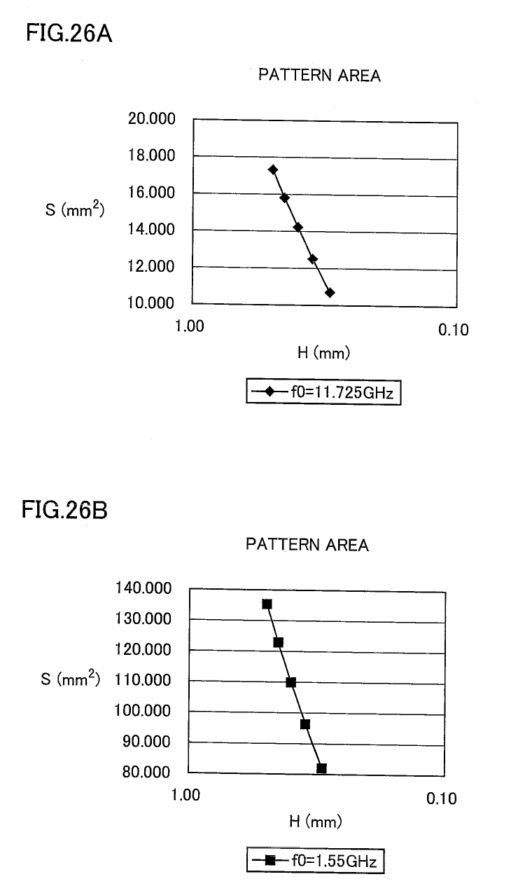

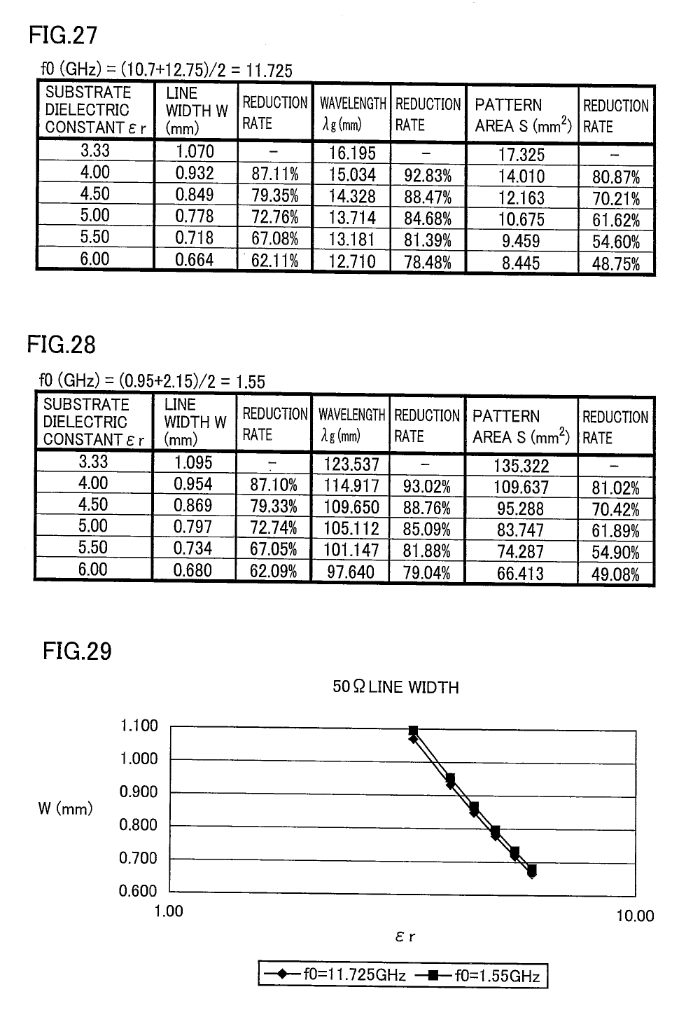

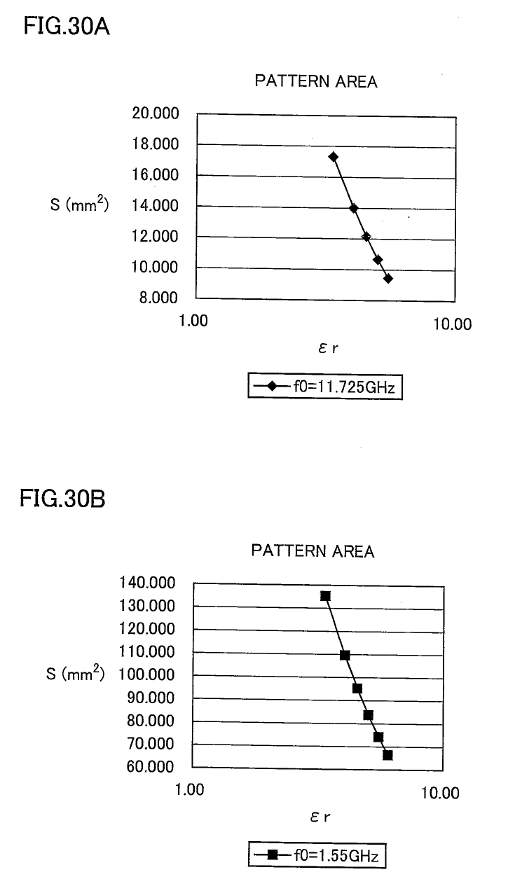

FIG. 17 illustrates the pass characteristic of the microstrip line in the example shown in FIGS. 15 and 16. FIG. 18 illustrates the pass characteristic of the microstrip line when casing 34 is removed from the high-frequency circuit in the example shown in FIGS. 15 and 16.

In FIGS. 15 to 18, R04233 produced by Rogers Corporation is used as the substrate. This substrate has a dielectric constant of 3.33 at 10 GHz and a dielectric dissipation factor of 0.0026 at 10 GHz. In addition, this substrate has a thickness of 0.5 mm. Moreover, the signal pattern of the microstrip line provided on this substrate has a thickness of 0.036 mm, a width of 0.6 mm and a length of 24 mm. This substrate is made of copper and has a weight of ½ ounce. In addition, the casing is made of aluminum die casting.

Referring to FIG. 16, a concave portion, that is, cutout portion 38 is provided in casing 34, which forms a space having a depth (c) of, for example, 0.5 mm from the main surface of signal pattern 11 and a width (a, b) of, for example, 0.3 mm from each of the right and left sides of signal pattern 11. In other words, as to the dimension of cutout portion 38 of casing 34, the horizontal width thereof is set to have a distance of 0.3 mm from each of the right and left sides of signal pattern 11, and the depth thereof is set to have a distance of 0.5 mm from the main surface of signal pattern 11.

Through hole 36 on the signal input side has a hole diameter of 0.4 mm and a land width of 0.2 mm. Through hole 37 on the signal output side has a hole diameter of 1.5 mm and a land width of 0.5 mm.

Referring to FIG. 17, the pass loss from through holes 36 to 37 in the present example is represented by a graph S21. The pass loss is 0.144 dB at 950 MHz, and 0.210 dB at 2150 MHz. In addition, the reflection characteristic at an input terminal, that is, through hole 36 on the signal input side is represented by a graph S11. The reflection characteristic at through hole 36 is 31.342 dB at 950 MHz, and 18.665 dB at 2150 MHz. In addition, the reflection characteristic at an output terminal, that is, through hole 37 on the signal output side is represented by a graph S22. The reflection characteristic at through hole 37 is 31.400 dB at 950 MHz, and 16.235 dB at 2150 MHz.

On the other hand, referring to FIG. 18, in the configuration in which casing 34 is removed from the high-frequency circuit of the present example and the upper part of the signal pattern of the microstrip line is opened, the pass loss from through holes 36 to 37 is represented by graph S21. The pass loss is 0.302 dB at 950 MHz, and 0.601 dB at 2150 MHz. In addition, the reflection characteristic at the input terminal, that is, through hole 36 on the signal input side is represented by graph S11. The reflection characteristic at though hole 36 is 22.769 dB at 950 MHz, and 14.336 dB at 2150 MHz. In addition, the reflection characteristic at the output terminal, that is, through hole 37 on the signal output side is represented by graph S22. The reflection characteristic at through hole 37 is 24.875 dB at 950 MHz, and 15.784 dB at 2150 MHz.

It can be seen from the comparison between FIGS. 17 and 18 that introduction of the structure of casing 34 in high-frequency circuit 103 results in small pass loss and excellent reflection characteristic in the high-frequency circuit. This indicates that casing 34 allows the impedance of the microstrip line to be set to around 50 Ω.

In other words, the signal pattern width of the 50 Ω microstrip line in the dielectric substrate is 1.1 mm in the prior art, whereas the signal pattern width of the 50 Ω microstrip line is 0.6 mm in high-frequency circuit 103. Therefore, the microstrip line can be designed such that the size thereof is reduced to about 55% of the original size.

In the high-frequency circuit according to the third embodiment of the present invention, metal casing 34 is in close contact with second earth pattern 15 and has cutout portion 38 forming space 35 that covers signal pattern 11. With such a configuration, it is not required to separately provide and mount the metal member as in the high-frequency circuit according to the first and second embodiments of the present invention, and thus, further downsizing of the high-frequency circuit, the LNB and the bidirectional satellite transmitting and receiving system can be achieved.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A high-frequency circuit, comprising:
a dielectric substrate having a first main surface and a second main surface provided on an opposite side of said first main surface;
a first earth pattern provided on said second main surface;
a signal pattern provided on said first main surface and configuring a microstrip line together with said dielectric substrate and said first earth pattern;
a second earth pattern provided on said first main surface and spaced from said signal pattern;
a metal member electrically connected to said second earth pattern, and facing said signal pattern with a spacing between said metal member and said signal pattern; and
a metal casing electrically connected to said first earth pattern and said second earth pattern, and housing said dielectric substrate, said microstrip line and said metal member.

2. The high-frequency circuit according to claim 1, wherein
said metal member is provided to surround said signal pattern and extend along a direction in which said signal pattern extends.

3. The high-frequency circuit according to claim 1, wherein
said metal member is integral with said metal casing.

4. The high-frequency circuit according to claim 1, wherein
said metal casing has a cutout portion being in close contact with said second earth pattern and forming a space that covers said signal pattern, and
said metal member is configured by said cutout portion.

5. A low noise block down converter, comprising:
a mixer for converting a frequency of a received radio signal; and
a high-frequency circuit for transmitting said radio signal or a signal whose frequency is converted by said mixer, and
said high-frequency circuit including:
a dielectric substrate having a first main surface and a second main surface provided on an opposite side of said first main surface;
a first earth pattern provided on said second main surface;
a signal pattern provided on said first main surface and configuring a microstrip line together with said dielectric substrate and said first earth pattern;
a second earth pattern provided on said first main surface and spaced from said signal pattern;
a metal member electrically connected to said second earth pattern, and facing said signal pattern with a spacing between said metal member and said signal pattern; and
a metal casing electrically connected to said first earth pattern and said second earth pattern, and housing said dielectric substrate, said microstrip line and said metal member.

6. An antenna apparatus, comprising:
an antenna for receiving a radio signal; and
a low noise block down converter for amplifying said radio signal and converting a frequency of said radio signal,
said low noise block down converter including:
a mixer for converting the frequency of said radio signal; and
a high-frequency circuit for transmitting said radio signal or a signal whose frequency is converted by said mixer, and
said high-frequency circuit including:
a dielectric substrate having a first main surface and a second main surface provided on an opposite side of said first main surface;
a first earth pattern provided on said second main surface;
a signal pattern provided on said first main surface and configuring a microstrip line together with said dielectric substrate and said first earth pattern;
a second earth pattern provided on said first main surface and spaced from said signal pattern;
a metal member electrically connected to said second earth pattern, and facing said signal pattern with a spacing between said metal member and said signal pattern; and
a metal casing electrically connected to said first earth pattern and said second earth pattern, and housing said dielectric substrate, said microstrip line and said metal member.
